(19) United States
(12) Patent Application Publication
(10) Pub. No.: US 2020/0141307 A1
(43) Pub. Date: May 7, 2020

(54) ACTUATOR ASSEMBLY FOR A TURBOCHARGER

(71) Applicant: BorgWarner Inc., Auburn Hills, MI (US)

(72) Inventors: Mariusz STASZOWSKI, Rzeszow (PL); Piotr POLANSKI, Rzeszow (PL); Adam PRYMON, Wiazownica (PL)

(21) Appl. No.: 16/619,348

(22) PCT Filed: Jun. 7, 2018
(86) PCT No.: PCT/US2018/036456

§ 371 Date: Dec. 4, 2019

(30) Foreign Application Priority Data
Jun. 8, 2017 (DE) 202017103441.0

(51) Int. Cl. F02B 27/02; F01D 7/00; F01D 11/00

(52) U.S. Cl. CPC F02B 27/0294; F01D 11/003; F01D 7/00

(57) ABSTRACT

The invention relates to an actuator assembly for a turbocharger comprising a shaft which is designed to be rotatably mounted in a housing of a turbocharger, wherein the shaft is coupled at a first end to an adjusting element and at a second end to a control element. The actuator assembly additionally comprises a cylindrical seal insert which is arranged about a center area of the shaft between the first end and the second end and extends along the shaft in the axial direction.

### CROSS-REFERENCE TO RELATED APPLICATIONS

This application claims the benefit of German Patent Application No. 202017103441.0 filed Jun. 8, 2017, the disclosure of which is herein incorporated by reference in its entirety.

### FIELD OF THE INVENTION

The present invention relates to an actuator assembly for a turbocharger, a turbine comprising a corresponding actuator assembly, and a corresponding exhaust gas turbocharger.

### BACKGROUND INFORMATION

Increasingly more vehicles of the more recent generation are equipped with charging devices. In order to achieve the target demands and the legal requirements, it is imperative to promote development in the complete drive train and also to optimize the individual components as well as the system as a whole with respect to their reliability and efficiency.

Exhaust gas turbochargers are known, for example, in which a turbine with a turbine wheel is driven by the exhaust gas flow of the internal combustion engine. A compressor with a compressor wheel, which is arranged with a turbine wheel on a mutual shaft, compresses the fresh air taken in for the engine. By this means, the air or oxygen amount, available to the engine for combustion, is increased, which in turn leads to an increased output of the internal combustion engine.

Known turbines comprise a turbine housing in which a turbine wheel is arranged. A turbine may additionally comprise additional devices, like a variable turbine geometry or a wastegate (turbine bypass valve), which improve the output, efficiency and operating behavior of the turbine. To actuate these types of devices, there are corresponding actuator assemblies, which transfer a movement of an actuator, which is often fixed externally on the turbine housing or on another component of a turbocharger (for example, a compressor housing), to a corresponding control element which is usually arranged within the turbine housing. Correspondingly, these types of actuator assemblies often have a shaft which extends from inside the turbine housing through a wall of the turbine housing to the outside of the turbine housing. To prevent a gas discharge in this area, corresponding means for sealing are provided. For example, one or more piston rings are known in combination with one or more O-rings. However, sealing means of these types require an expensive processing of the shaft to provide corresponding accommodation grooves for the piston rings/O-rings, and do not always provide the desired result.

Accordingly, the object of the present invention is to provide an optimized actuator assembly for a turbocharger which has an improved sealing that is easier to assemble.

### BRIEF SUMMARY OF THE INVENTION

The present invention relates to an actuator assembly for a turbocharger according to Claim 1, a turbine according to Claim 11, and an exhaust gas turbocharger according to Claim 15.

The actuator assembly according to the invention comprises a shaft which is designed to be rotatably mounted in a housing of a turbocharger, wherein the shaft is coupled at a first end to an adjusting element and at a second end to a control element. The actuator assembly additionally comprises a cylindrical seal insert which is arranged about a center area of the shaft between the first end and the second end and extends along the shaft in the axial direction. Due to the actuator assembly according to the invention with the cylindrical seal insert, the piston rings and O-rings, previously used in this area for the purpose of sealing, may be omitted. In addition, the machining steps on the shaft for generating the grooves required for the piston rings and O-rings may be omitted, by which means the manufacturing costs for the actuator assembly may be reduced. Another advantage is the simplified assembly of the actuator assembly according to the invention, because only one seal insert has to be mounted instead of up to three piston rings and additional O-rings.

In embodiments, the seal insert may have spring properties in the radial direction. A better sealing effect results due to the spring properties of the cylindrical seal insert, for example, against the leakage of exhaust gases from within the housing. Furthermore, susceptibility with respect to vibrations, which lead to undesired noise and wear, is reduced due to the cylindrical embodiment in combination with the spring properties. In sum, a better damped mounting of the shaft in the housing results, which positively affects the functionality/controllability of the actuator assembly and the life cycle of all components of the actuator assembly and thus ultimately also a turbocharger that comprises an actuator assembly according to the invention.

In embodiments, which are combinable with all previously described embodiments, the seal insert may have a wave-shaped contour in the axial direction. Alternatively, the seal insert may have a stepped contour in the axial direction.

In embodiments, which may be combined with all previously described embodiments, the seal insert may have a circumferentially closed cylindrical shape. Alternatively, the seal insert may have a circumferentially open cylindrical shape. In particular, the seal insert may have a slit extending axially.

In embodiments, which may be combined with all previously described embodiments, a bush may be provided, wherein the seal insert is arranged between the shaft and the bush in the radial direction. The bush may be designed to be arranged rotationally fixed in a housing. The shaft may be rotatably mounted in the bush. A maximum diameter of the seal insert may be larger in the expanded state of the seal insert than the inner diameter of the bush.

In embodiments, which may be combined with all previously described embodiments, the shaft may have a reduced diameter along the center area, about which the seal insert is arranged, in comparison to the areas adjacent to the center area. During the assembly of the actuator assembly, the seal insert may be positioned in the center area and then inserted together with the shaft into the bush. Due to the spring effect, the seal insert is compressed during the insertion into the bush, by which means the sealing effect is generated.

In embodiments, which may be combined with all previously described embodiments, the actuator assembly may be a wastegate assembly. Alternatively, the actuator assembly may be designed for adjusting a variable turbine geometry.

The invention additionally comprises a turbine for an exhaust gas turbocharger with a turbine housing and an actuator assembly according to any one of the previously described embodiments.

In embodiments, the turbine housing may have a hole through an outer wall of the turbine housing, wherein the shaft extends through the hole so that the first and second ends of the shaft are arranged on opposite sides of the outer wall. The seal insert may be arranged radially between a wall of the hole and the shaft. Alternatively, a bush may be provided which is arranged rotationally fixed in the hole. The seal insert is the arranged between the shaft and the bush, and the bush is arranged radially between the seal insert and the wall of the hole.

The invention additionally comprises an exhaust gas turbocharger with a turbine according to any one of the previously described embodiments.

Additional details and features of the invention are subsequently described by way of the figures.

### BRIEF DESCRIPTION OF THE DRAWINGS

FIG. 1 shows a cutaway view of an actuator assembly known from the prior art;

FIG. 2 shows a cutaway view of one embodiment of the actuator assembly according to the invention.

### DETAILED DESCRIPTION OF THE INVENTION

Embodiments of the actuator assembly 100 according to the invention will subsequently be described based on the figures. All details and advantages subsequently described apply both for actuator assembly 100 and also for a corresponding turbine comprising such an actuator assembly 100. Within the context of this application, the term “axial” refers to directions/orientations that extend substantially parallel to the axis of rotation 300. The term “radial” refers to directions/orientations that extend substantially perpendicular to axis of rotation 300.

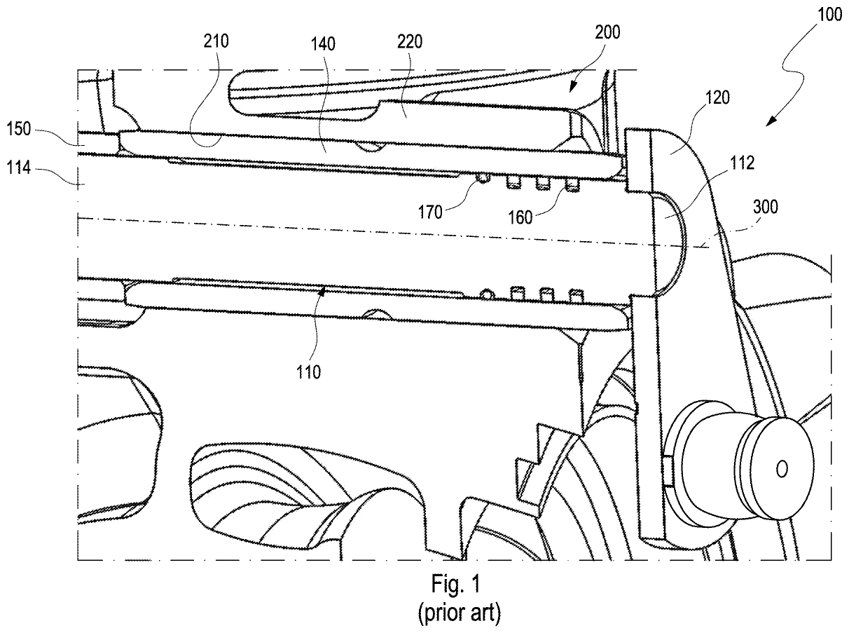

FIG. 1 shows an actuator assembly 100 for a wastegate (turbine bypass valve) of a turbine from the prior art. The actuator assembly comprises a shaft 110 which is rotatably mounted in turbine housing 200 of the turbine. Shaft 110 is coupled at a first end 112 to an adjusting element 120. The adjusting element may itself be connected, for example, to an actuator (not shown) via a coupling rod (not shown), so that a movement of the actuator causes a rotation of shaft 110. Shaft 110 is coupled at its second end 114 to a control element 150. Control element 150 may, for example, be part of a flap of the wastegate arrangement that closes or releases a wastegate channel. In the case of the actuator assembly from FIG. 1, a bush 140 is additionally provided in which shaft 110 is rotatably mounted. Bush 140 is itself arranged rotationally fixed in a hole 210 in an outer wall 220 of turbine housing 200. In this known actuator assembly 100, three piston rings 160 and an O-ring 170 are provided as sealing means.

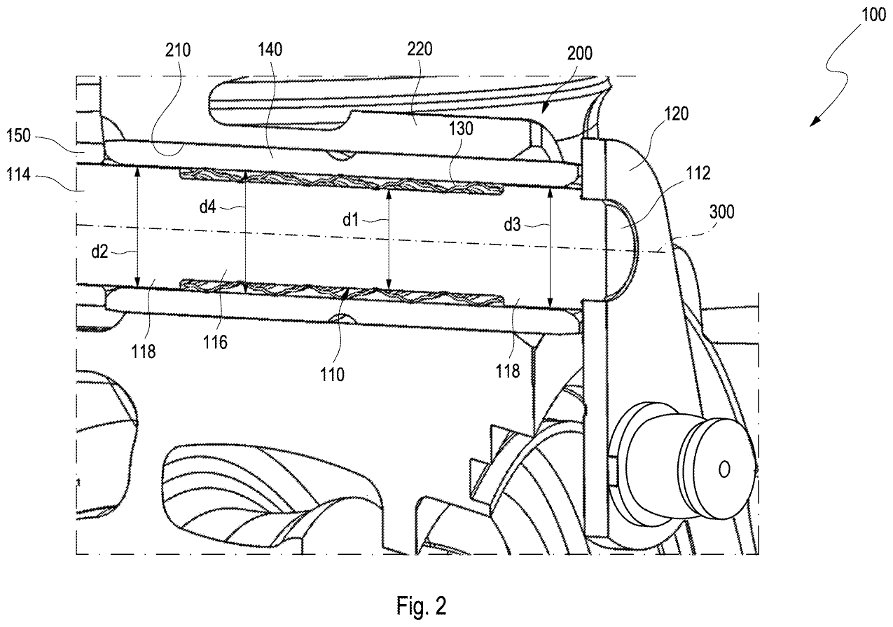

FIG. 2 shows an actuator assembly 100 according to the invention. Identical components in FIG. 1 and FIG. 2 are provided with identical reference numerals to facilitate understanding. Actuator assembly 100 according to the invention is subsequently described by way of FIG. 2 for the exemplary arrangement in a turbine for use with a wastegate valve (turbine bypass valve). Actuator assembly 100 according to the invention may also be used just as well for actuating a variable turbine geometry (VTG) or other adjustable components of a charging device (for example, components of a variable compressor inlet).

Actuator assembly 100 according to the invention likewise comprises a shaft 110 which is rotatably mounted in a turbine housing 200. Shaft 110 is again coupled at its first end 112 to an adjusting element 120 and at its second end 114 to a control element 150. The actuator assembly according to the invention additionally comprises a cylindrical seal insert 130 which is arranged about a center area 116 of shaft 110 between first end 112 and second end 114 and extends along shaft 110 in the axial direction (see FIG. 2). Due to actuator assembly 100 according to the invention comprising cylindrical seal insert 130, piston rings 160 and O-rings 170, previously used in this area for sealing purposes (see FIG. 1), may be omitted. In addition, the machining steps for shaft 110 for generating the grooves necessary for piston rings 160 and O-rings 170 may be omitted, by which means the manufacturing costs for actuator assembly 100 are reduced. Another advantage is the simplified assembly of actuator assembly 100 according to the invention, because only one seal insert 130 has to be mounted instead of up to three piston rings 160 and additional O-rings 170.

During actuation of the actuator assembly, shaft 110 rotates about axis of rotation 300, driven by an actuator that transmits a movement to shaft 110 via adjusting element 120. Shaft 110 then transmits the movement to control element 150 (for example, as part of a wastegate valve, for opening or closing the wastegate valve).

Sealing insert 130 has spring properties in the radial direction. An improved sealing effect results due to the spring properties of cylindrical seal insert 130, for example, against the leakage of exhaust gases from within turbine housing 200 into the environment. Furthermore, susceptibility with respect to vibrations, which lead to undesired noise and wear, is reduced by the cylindrical embodiment of seal insert 130 in combination with the spring properties. In sum, a better damped mounting of shaft 110 in turbine housing 200 results, which positively affects the functionality and controllability of actuator assembly 100 and the life cycle of all components of actuator assembly 100 and thus ultimately also a turbocharger that comprises an actuator assembly 100 according to the invention.

As is clear in FIG. 2, seal insert 130 has a wave-shaped contour in the axial direction. The wave-shaped contour in the axial direction generates a spring effect in the radial direction, because seal insert 130 may be compressed radially inward due to the wave-shaped configuration, even if shaft 110 is already located within cylindrical seal insert 130. Alternatively, seal insert 130 may have a stepped contour in the axial direction. The stepped contour has the same effect as the wave-shaped contour. It may also have a double-wave-shaped contour (for example, with multiple layers) or a contour may be provided made, for example, from “overlapping” small waves (lower amplitude and shorter wave length) along a larger wave shape (larger amplitude and larger wave length) (as is indicated in FIG. 2), to maintain the desired spring effect. Other contour shapes may also be provided which lend seal insert 130 a spring effect in the radial direction due to this design.

Seal insert 130 may have a circumferentially closed cylinder shape. Alternatively, seal insert 130 may have a circumferentially open cylinder shape. In this case, seal insert 130 may have a slit extending axially. Seal insert 130 may be manufactured, for example, in a stamping method, in which a cylindrical stamped blank is provided with a corresponding structure to provide the spring effect. Alternatively, seal insert 130 may be manufactured from a metal sheet, wherein the metal sheet has a corresponding structure, and after a cutting process is shaped into the final cylindrical shape. The axially extending slit is thereby created, which increases the elasticity of seal insert 130 and may be completely closed in the installed state of seal insert 130. In both cases, the material used (in particular heat resistant metals of all types) may be heat treated.

As is clear in FIG. 2, turbine housing 200 has a hole 210 through an outer wall 220 of turbine housing 200, wherein shaft 110 extends through hole 210 so that first and second ends 112, 114 of shaft 110 are arranged on opposite sides of outer wall 220. In the embodiment from FIG. 2, a bush 140 is additionally provided, which is arranged rotationally fixed in hole 210 through outer wall 220. Shaft 110 is rotatably mounted in bush 140. Seal insert 130 is arranged between shaft 110 and bush 140 in the radial direction and bush 140 is arranged radially between seal insert 130 and a wall of hole 210. In addition, first and second bearing areas 118 are provided along the shaft which are in contact with an inner side of bush 140 and form a sliding bearing for shaft 110 in bush 140 so that shaft 110 may be rotated in bush 140 to move control element 150. Alternatively, bush 140 may also not be provided, wherein seal insert 130 is then arranged radially between a wall of hole 210 and shaft 110. Thus, either no bush 140 may be provided, so that shaft 110 is rotatably mounted directly in hole 210 and seal insert 130 is positioned between shaft 110 and turbine housing 200 and is in contact with shaft 110 and turbine housing 200. Alternatively, as is depicted in FIG. 2, a bush 140 is provided which is arranged rotationally fixed in hole 210 of turbine housing 200. In this case, shaft 110 is rotatably mounted in bush 140 and seal insert 130 is positioned between shaft 110 and bush 140 and contacts shaft 110 and bush 140.

A maximum diameter of seal insert 130 may be larger in the expanded state of seal insert 130 than the inner diameter d4 of bush 140 (see FIG. 2). In addition, shaft 110 has a reduced diameter d1 along the center area 116, about which seal insert 130 is arranged, with respect to the areas adjacent to the center area. Center area 116 with reduced diameter d1 simultaneously defines in part the two adjacent bearing areas 118 with larger diameters d2 and d3 with respect to diameter d1, wherein d2 and d3 may be the same size or may be different sizes. During the assembly of actuator assembly 100, seal insert 130 may be positioned along center area 116 with reduced diameter d1 and then inserted into bush 140 together with shaft 110. Due to the spring effect, seal insert 130 is compressed during the insertion into bush 140, by which means the sealing effect is ultimately generated, as due to the spring effect of seal insert 130, contact is maintained both with shaft 110 and also the inner wall of bush 140.

As already mentioned, the invention comprises both an actuator assembly 100 and also a turbine for an exhaust gas turbocharger comprising one of the previously described embodiments of actuator assembly 100. In addition, the invention comprises an exhaust gas turbocharger comprising a turbine of this type.

1. An actuator assembly (100) for a turbocharger comprising a shaft (110) which is designed to be rotatably mounted in a housing (200) of the turbocharger, wherein the shaft (110) is coupled at a first end (112) to an adjusting element (120) and at a second end (114) to a control element (150);
characterized by a cylindrical seal insert (130), which is arranged about a center area (116) of the shaft (110) between the first end (112) and the second end (114) and extends in an axial direction along the shaft (110).

2. The actuator assembly according to claim 1, characterized in that the seal insert (130) has spring properties in a radial direction.

3. The actuator assembly according to claim 1, characterized in that the seal insert (130) has a wave-shaped contour in the axial direction.

4. The actuator assembly according to claim 1, characterized in that the seal insert (130) has a stepped contour in the axial direction.

5. The actuator assembly according to claim 1, characterized in that the seal insert (130) has a circumferentially closed cylindrical shape; or
characterized in that the seal insert (130) has a circumferentially open cylindrical shape, wherein seal insert (130) has a slit extending axially.

6. The actuator assembly according to claim 1, characterized by a bush (140), wherein the seal insert (130) is arranged between the shaft (110) and the bush (140) in a radial direction.

7. The actuator assembly according to claim 6, characterized in that the bush (140) is designed to be arranged rotationally fixed in a housing (200), and that the shaft (110) is rotatably mounted in the bush (140).

8. The actuator assembly according to claim 6, characterized in that a maximum diameter of the seal insert (130) in an expanded state of the seal insert (130) is greater than an inner diameter (d4) of the bush (140).

9. The actuator assembly according to claim 1, characterized in that the shaft (110) has a reduced diameter (d1) along a center area (116) about which the seal insert (130) is arranged with respect to areas adjacent to the center area.

10. The actuator assembly according to claim 1, characterized in that the actuator assembly is a wastegate assembly; or characterized in that the actuator assembly is designed for adjusting a variable turbine geometry.

11. A turbine for an exhaust gas turbocharger, comprising a turbine housing (200); and
an actuator assembly (100) comprising a shaft (110) which is designed to be rotatably mounted in a housing (200) of the turbocharger, wherein the shaft (110) is coupled at a first end (112) to an adjusting element (120) and at a second end (114) to a control element (150);
characterized by a cylindrical seal insert (130), which is arranged about a center area (116) of the shaft (110) between the first end (112) and the second end (114) and extends in an axial direction along the shaft (110).

12. The turbine according to claim 11, characterized in that the turbine housing (200) has a hole (210) through an outer wall (220) of the turbine housing (200), wherein the shaft (110) extends through the hole (210) so that the first and second ends (112, 114) of the shaft (110) are arranged on opposite sides of the outer wall (220).

13. The turbine according to claim 12, characterized in that the seal insert (130) is arranged radially between a wall of the hole (210) and the shaft (110).

14. The turbine according to claim 12, characterized in that a bush (140) is provided which is arranged rotationally fixed in the hole (210), and that the seal insert (130) is arranged between the shaft (110) and the bush (140) and the bush (140) is arranged radially between the seal insert (130) and a wall of the hole (210).

15. An exhaust gas turbocharger comprising a turbine for an exhaust gas turbocharger, comprising
a turbine housing (200); and
an actuator assembly (100) comprising a shaft (110) which is designed to be rotatably mounted in a housing (200) of the turbocharger, wherein the shaft (110) is coupled at a first end (112) to an adjusting element (120) and at a second end (114) to a control element (150);
characterized by a cylindrical seal insert (130), which is arranged about a center area (116) of the shaft (110) between the first end (112) and the second end (114) and extends in an axial direction along the shaft (110).

16. The actuator assembly according to claim 2, characterized in that the seal insert (130) has a wave-shaped contour in the axial direction.

17. The actuator assembly according to claim 2, characterized in that the seal insert (130) has a stepped contour in the axial direction.

18. The actuator assembly according to claim 2, characterized by a bush (140), wherein the seal insert (130) is arranged between the shaft (110) and the bush (140) in a radial direction.
